(19) United States
(12) Patent Application Publication
(10) Pub. No.: US 2007/0016377 A1
(43) Pub. Date: Jan. 18, 2007

(54) SYSTEM AND METHOD FOR IMPROVED COMPUTER DRUG DESIGN

(76) Inventor: Chris M.W. Ho, St. Louis, MO (US)

Correspondence Address: WOODARD, EMHARDT, MORIARTY, MCNETT & HENRY LLP, 111 MONUMENT CIRCLE, SUITE 3700, INDIANAPOLIS, IN, 46204-5137, US

(21) Appl. No.: 11/383,849

(22) Filed: May 17, 2006

Related U.S. Application Data
(63) Continuation of application No. 10/288,851, filed on Nov. 6, 2002.
(60) Provisional application No. 60/332,711, filed on Nov. 6, 2001.

(51) Int. Cl. G06F 19/00

(52) U.S. Cl. 702/19; 702/22

(57) ABSTRACT

A system and method for computer-aided drug design is less restricted by accuracy of calculated ligand-receptor binding affinity, better copes with the flexibility of ligands and its effect on binding affinity, and limits the generation of undesirable compounds and the likelihood of biasing results with assumptions made in development.

### PRIORITY

This continuation patent application claims priority from U.S. Provisional Patent Application No. 60/332,711, filed Nov. 6, 2001, and U.S. Utility Patent Application No. 10/288,851, filed Nov. 6, 2002, the entire specifications of which are hereby incorporated herein.

### BACKGROUND OF THE INVENTION

As is known by those skilled in the art, the vast majority of drugs are small molecules designed to bind, interact, and modulate the activity of specific biological receptors. Receptors are proteins that bind and interact with other molecules to perform the numerous functions required for the maintenance of life. They include an immense array of cell-surface receptors (hormone receptors, cell-signaling receptors, neurotransmitter receptors, etc.), enzymes, and other fimctional proteins. Due to genetic abnormalities, physiologic stresses, or some combination thereof, the number, structure, or function of specific receptors and enzymes may become altered to the point that our well-being is diminished. These alterations may manifest as minor physical symptoms, as in the case of a runny nose due to allergies, or as life threatening and debilitating events, such as sepsis or depression. The role of drugs is to modulate the number, structure, or activity of these receptors to remedy the resulting medical condition.

Enzymes are a subset of receptor-like proteins that are directly responsible for catalyzing the biochemical reactions that sustain life. For example, digestive enzymes act to break down the nutrients of our diet. DNA polymerase and related enzymes are crucial for cell division and replication. Enzymes are genetically programmed to be absolutely specific for their appropriate molecular targets. Any errors could have grave consequences. For example it would likely be fatal if blood-clotting enzymes began activating throughout the body, or if our inunune system began attacking our own tissues. Enzymes ensure the specificity of their targets by forming a molecular environment that excludes interactions with inappropriate molecules. The analogy most often mentioned is that of a lock and key. The enzyme is a molecular lock, which contains a keyhole that exhibits a very specific and consistent size and shape. This molecular keyhole is termed the active site of the enzyme and allows interaction with only the appropriate molecular targets. Just as a typical lock is much bigger than the keyhole, the receptor is usually much larger than the active site. The receptor, as specified by our DNA, is a folded protein whose major purpose is to form and maintain the size and shape of the active site. This is illustrated in FIG. 1 using the structure of the HIV-1 protease, indicated generally at 100. The active site is indicated at 110.

The most important aspect of drug design relates to the mechanism by which the active site of a receptor selectively restricts the binding of inappropriate structures. Any potential molecule that can bind to a receptor is called a “ligand.” In order for a ligand to bind, it must contain a specific combination of atoms that presents the correct size, shape, and charge composition in order to bind and interact with the receptor. The ligand must possess the molecular “key” that binds the receptor lock.

FIG. 2 schematically shows a typical ligand-receptor binding interaction. The ligand is indicated at 200, and the walls of the active site 110 are shown at 210. For ligand-receptor interaction to occur, the ligand 200 must be complementary in size and shape to the receptor active site 110. This is known as “steric complementarity.” The more close the fit between the ligand and receptor, the tighter the interaction becomes. If a molecule varies from a fimctioning ligand by even a single atom in the wrong place, it may not fit properly, and therefore not interact with the receptor, or not interact strongly enough. Note that, although the schematic illustration of FIG. 2 is two-dimensional, both ligand 200 and active site 110 are three-dimensional.

In addition to steric complementarity, electrostatic interactions influence ligand binding. Charged receptor atoms often surround the active site 110, imparting a localized charge in specific regions of the active site. In FIG. 2, regions of relative negative charge are indicated at 220, while regions of relative positive charge are shown at 230. It will be appreciated by those skilled in the art that opposite charges attract while similar charges repel. Electrostatic complementarity further restricts the binding of inappropriate molecules, since the ligand 200 must contain correctly placed complementary charged atoms for it to interact with the active site 110.

It will be appreciated by those skilled in the art that the strongest driving force for ligand and receptor binding is “hydrophobic interaction.” Nearly two-thirds of the body is water, and this aqueous milieu surrounds all our cells. In order for ligand and receptor to interact, there must be a driving force that compels the ligand to leave the water and bind to the receptor. The hydrophobicity of a ligand is what causes this. Hydrophobicity is a measure of how “greasy” a compound is. It can be roughly approximated by the percentage of hydrogen and carbon in the molecule. This force can be demonstrated by placing a few drops of oil in a cup of water. The oil is composed of hydrocarbon chains and is highly hydrophobic. The oil droplets will rapidly coalesce into a single globule in order to avoid the water, which is highly polar. As shown in FIG. 2, the active site may contain a mixture of hydrophobic pockets and regions that are more polar. Since the hydrophobic portions of the ligand and receptor prefer to be juxtaposed, the arrangement of hydrophobic surfaces provides yet another way that receptors can limit the binding of inappropriate targets.

As discussed above, there are numerous potential interactions between ligand and receptor. Depending upon the size of the active site, there may be a myriad steric, electrostatic, and hydrophobic contacts. However, some are more important than others. The specific interactions that are crucial for ligand recognition and binding by the receptor are called the “pharmacophore.” Usually, these are the interactions that directly factor into the structural integrity of a receptor or are involved in the mechanism of its action. Only a molecule that presents the pharmacophore to the receptor properly interacts with the active site. This is crucial to the design of pharmaceuticals since any successful drug must incorporate the appropriate chemical structures and present the pharmacophore to the receptor.

This is illustrated in FIG. 3. A first molecule 310 is a native ligand bound within the active site. Assume that through biochemical investigation, we determine that the phenyl ring 322 and the carboxylic acid group 324 are vital to receptor interaction. Thus, we deduce that these two groups must be the pharmacophore 320 that a ligand must present to the receptor for binding. In future drugs that we develop to mimic the native ligand 310, we must include these two pharmacophoric elements for successful binding to occur. For example, the first derivative compound 330 in which a bicyclic group has been substituted maintains the pharmacophore and retains its complementary size and shape. The derivative compound 330 therefore has a reasonable chance of successfully binding. However, any drug that we develop which lacks a complete pharmacophore, such as the second derivative compound 340 shown in FIG. 3, may not interact with the receptor target.

When a medical condition exists where a drug could be beneficial, extensive scientific study must first be done in order to determine the biological and biochemical problems that underlie the disease process. This often takes years of study in order to characterize the targets for a potential drug. The reason is that nearly all biological processes in the human body are tightly interconnected. Altering the behavior of select receptors or enzymes may have detrimental effects with other systems. These are the side effects that occur with nearly all drugs. Furthermore, the human body is a homeostatic machine, and always attempts to achieve equilibrium. As a result, the body will attempt to counteract any pharmacotherapeutic intervention.

Once a receptor target has been established and well characterized, the process of ligand design begins. The designed ligand must complement the active site of the receptor target. Steric, electrostatic, and hydrophobic complementarity must be established, as discussed above. The pharmacophore must be presented to the receptor in order for recognition and binding to occur. Otherwise, the designed ligand will have no chance of interacting with the receptor.

In addition to adequately binding the receptor, the biochemical mechanism of the receptor target must be taken into consideration. FIGS. 4A and 4B schematically represent the biochemical mechanism of a protease 400. A protease is an enzyme that cleaves proteins and peptides. FIG. 4A shows that a protease 400 recognizes a specific group of atoms 410, that is a peptide bond in a ligand 450. If the peptide bond 410 is present at a specific position in the active site when the ligand 450 binds, it is cleaved by the protease with the addition of water (H₂O) to form two separate fragments 420. If the goal is to inactivate this protease, any designed ligand must not possess this peptide bond at the same position. Otherwise, it will simply be cleaved by the protease 400, and the protease 400 will continue to function unperturbed. However, the ligand 450 can be modified to produce a different ligand 455, in which the peptide bond 410 is no longer present as shown in FIG. 4B. If the ligand 455 is bound by the enzyme 400, the enzyme 400 will not be able to cleave it. The enzyme 400 would therefore be inactivated, as the ligand 455 remains lodged in the active site 110.

Once the active site region 110 and the mechanism of action of the target receptor have been characterized, a suitable ligand must be designed. This is typically the most demanding task of the entire drug design process. The optimal combination of atoms and functional groups to complement the receptor is often the natural ligand of the receptor. This is usually an unacceptable candidate for a drug. This may be, for example, because the natural ligand is inactivated by the receptor, as described above, or because it is not feasible to commercially manufacture the natural ligand. Therefore, alternative combinations of chemical structures must be devised.

Those skilled in the art will appreciate that the design of novel ligands is often restricted by what chemists are physically able to synthesize. It is of no use to design the ultimate drug if it cannot be manufactured. Each atom type has a specific size, charge, and geometry with respect to the number and types of neighboring atoms that it can be joined to. The entire field of chemistry is predicated on the establishment of synthetic rules for the construction and manipulation of various combinations of atoms and functional groups. These chemical rules govern the design and synthesis of postulated ligand candidates. Within these rules, the drug developer must creatively propose suitable chemical structures that satisfy the requirements discussed above.

Finally, there are biological considerations to the development of new drugs. For example, the liver is the major organ of detoxification in the human body. Any drug that is taken undergoes a number of chemical reactions in the liver as the body attempts to neutralize foreign substances. This set of reactions is well characterized, and a great deal of knowledge exists as to how drugs are modified as the body eliminates them. For another, even more important example, various chemical structures are highly toxic to biological systems, and these are also well characterized. These constraints must also be taken under consideration as novel drugs are developed.

As discussed above, the development of any potential drug begins with scientific study to determine the biochemistry behind a medical problem for which pharmaceutical intervention is possible. This allows the determination of specific receptor targets that must be modulated to alter their activity in some way. Once these targets have been identified, compounds must be found that will interact with the receptors in some fashion. At this initial stage of drug development, it does not matter what effect the compounds have on the targets. We simply wish to find anything that binds to the receptor in any fashion.

A typical drug-discovery pipeline is outlined in FIG. 5, shown generally at 500. The first step 520 is to use biological data 510 to determine an “assay” for the receptor. An assay is a chemical or biological test that turns positive when a suitable binding agent interacts with the receptor. Usually, this test is some form of colorimetric assay, in which an indicator turns a specific color when complementary ligands are present. This assay is then used in mass screening 530, which is a technique whereby hundreds of thousands of compounds can be tested in a matter of days to weeks. Typically, a pharmaceutical company will first screen their entire corporate database of known compounds. The reason is that if a successful match is found, the database compound is usually very well characterized. Furthermore, synthetic methods will be known for this compound. This enables the company to rapidly prototype a candidate ligand whose chemistry is well known.

If a successful match is found, the initial hit is called a “lead compound” 540. The lead compound 540 is usually a weakly binding ligand with minimal receptor activity. The binding of this structure to the receptor is then studied at 550 to determine the interactions that foster the ligand-receptor association. If the receptor is water soluble, there is a chance that x-ray crystallographic analysis can be employed to determine the three-dimensional structure of the ligand bound to the receptor at the atomic level. This is a very powerful tool because it allows scientists to directly visualize a snapshot of the individual atoms of the ligand as they reside within the receptor. This snapshot is referred to as the “crystal structure” of the ligand-receptor complex. Unfortunately, not all complexes can be analyzed in this manner. However, if a crystal structure can be determined, a strategy can then be developed based upon this characterization to improve and optimize the binding of the lead compound. From this point onward, a cycle of iterative chemical refinement and testing continues at 560 until a clinically active compound 570 is found. The techniques most often used to refine drugs at 560 are combinatorial chemistry and structure-based design. The clinically active compound 570 is then tested with patients in clinical trials at 580.

Combinatorial chemistry is one technique that aids in the refinement of the lead compound 540. Combinatorial chemistry is a synthetic tool that can rapidly generate many thousands of lead compound 540 derivatives for testing. A scaffold is employed that contains a portion of the ligand 540 that remains constant. Sites on the scaffold are then designated for derivatization, that is, designated for the addition of substituent functional groups from carefully designed chemical libraries, in a combinatorial fashion. As a result, a multitude of derivative structures, each with different substituent groups, may be rapidly generated in an automated fashion. For example, if a scaffold contains three derivatization sites and the library contains ten groups per site, theoretically 1000 different combinations are possible. By carefully selecting libraries based upon the study of the active site, the derivatization process can be targeted towards optimizing ligand-receptor interaction.

Structure based design (also called rational drug design), on the other hand, is much more focused than combinatorial chemistry. Biochemical laws of ligand-receptor association discussed above are used to postulate ligand refinements to improve binding. For example, as discussed above, steric complementarity is vital to tight receptor binding. Using the crystal structure of the complex, regions of the ligand that fit poorly within the active site can be identified, and chemical changes to improve complementarity with the receptor can be postulated. In a similar fashion, functional groups on the ligand can be changed in order to augment electrostatic complementarity with the receptor. However, the danger in altering any portion of the ligand is the effect on the remaining ligand structures. Modifying even a single atom in the middle of the ligand can drastically change the shape of the overall structure. Even though complementarity in one portion of the ligand might be improved by the chemical revision, the overall binding might be severely compromised. This is an important shortcoming of rational design procedures.

Computer aided drug design generally follows one of two strategies: de novo design and drug optimization. De novo design refers to construction of virtual lead compounds entirely through computer simulation. For the most part, de novo design has been unsuccessful. In order to make the calculations that simulate ligand construction and receptor-binding affinity run in a finite period of time, assumptions significant approximations, and numerous algorithmic shortcuts are generally required. This greatly diminishes the accuracy of any calculated ligand-receptor interaction. Thus, de novo design can postulate numerous chemical structures that can potentially complement the active site; however, the calculated binding affinity has little or no correlation with reality. Furthermore, de novo design often generates undesired structures, such as toxic or chemically unstable structures. Therefore, a large fraction of the potential ligands identified by de novo design are useless as a commercial drug.

Computer aided drug optimization, however, is an important tool in drug research. Drug optimization begins with a lead compound 540, which may have been identified by mass screening, through combinatorial chemistry, by x-ray crystallography, or some other means. Small modifications are then made to generate derivative compounds using structure-based design to improve binding affinity. Because the changes are relatively small the validity of the computed binding affinities of the derivatives is relatively high. The best of the derivatives can be tested to verify the accuracy of the calculated binding affinities. The process continues iteratively until satisfactory binding ligands are produced.

Prior art computer-aided drug design packages generally fall into one of three main genres: scanners, builders, and hybrids.

All database search programs fall into the scanner category. Scanner type programs are typically used for lead compound screening. FIG. 6A illustrates how these programs are used. A lead compound 540 whose binding structure has been determined resides within an active site. From biochemical analysis of the ligand-receptor interaction, the pharmacophore is determined. For example, in the lead compound 540 shown in FIG. 6A, it might be determined that three ligand groups make up the pharmacophore 620: a phenyl ring 612, an amide hydrogen 614, and a hydroxyl group 616. The pharmacophore 620 is transformed into a query 630 that specifies the three-dimensional relationship between the functional groups of the pharmacophore 620.

FIG. 6B illustrates the process by which a scanner package identifies potential new drugs. The scanner package requires a database 650 of compounds whose three-dimensional structures are known. The query 630 is then used to search the database 650 for compounds that mimic the pharmacophore 620 and can potentially bind to the receptor target. The scanner package then outputs a set of candidates 660.

Scanners have a number of advantages. In database search programs the user has complete control over the query specifications. This allows for the retrieval of structures that meet the requirements of the pharmacophore 620 and have a better opportunity to complement the receptor. Furthermore, because these programs use a database 650 of known compounds, synthetic feasibility is assured. These programs are typically highly optimized for speed, which allows for the rapid determination of potential binding ligands. Furthermore, since compounds are retrieved that mirror the query, no scoring functions that estimate receptor-binding affinity are required.

However, the scanner relies on the assumption that the three-dimensional structure stored in the database is representative of biological reality. Although this can be true of small molecules, larger structures are often too flexible for the assumption to hold true. Thus, scanners may miss important potential lead compounds that can flex to form a structure with a high binding affinity. Furthermore, scanners cannot generate new lead compounds—they are completely dependent upon the database 650 of structures with which it is supplied. Therefore, scanners cannot identify new structures, and their potential solutions are biased by the database they employ. Furthermore, generating a large database may require a great deal of manpower and funding, imposing a burden to commercial companies and potentially rendering scanner type software useless to academic institutions.

Builder-type programs may be used for de novo ligand design if a substantial portion of the ligand is modified. However, they are best used for the optimization of lead compounds. Like scanners, builder programs use a database of structures. However, a builder's database contains fragments and chemical building blocks instead of complete compounds. In order to optimize a lead compound with a builder, areas of the compound that poorly complement the corresponding receptor region must be identified, as shown in FIG. 7. The lead compound 710 contains a stable, tight-binding region 712, and a phenyl ring 714 that should be replaced to improve receptor complementarity. Builder-type programs require the attachment point of the weak-binding portion as input, shown at 716 on the example lead compound 710. The software then removes the offending ligand region and uses the attachment point 716 to create a population of derivatives by adding, deleting, and substituting fragments 718 chosen from the builder's component database to fill the active site. The binding energies of the resulting derivative ligands are then calculated. Those structures that augment binding are retained while those that do not are discarded. This process repeats as the new population of structures is then processed to generate the next round of derivatives. By making incremental changes iteratively, these programs generate a set of ligands with improved receptor complementarity over time.

Builder programs require less investment to use than scanners because the database is easier to generate. Furthermore, the component database is often built into the software itself. The combinatorial addition of fragments offers a vast number of potential derivative structures. Because components from numerous chemical classes are typically included, builder programs can automatically generate a diverse set of chemical solutions, which contributes to the creation of novel ligands. In addition, builders can also be used to optimize the hits that result from mass screening.

Unfortunately, the combinatorial attachment of such diverse chemical components also leads to the generation of synthetically unfeasible and chemically unstable structures. Also, although a diverse set of chemical building blocks is used, the manner in which they are attached is typically up to the developer of the software. Decisions such as when a particular component is selected and where it is attached greatly affect the generated structures. These choices reflect the bias of the program developers. Furthermore, the ability of builder programs to generate improved ligands is limited by the inability to accurately calculate the receptor-binding structure and binding affinity, as discussed above.

As with scanner packages, builder-type programs are also limited by their ability to deal with ligand flexibility. Builders attempt to deal with this limitation with “conformational searching.” It will be appreciated that a molecule is actually composed of rigid chemical groups separated by rotatable bonds, as defined by the laws of chemistry. These rotatable bonds give a ligand inherent flexibility, so that it can adopt numerous configurations as it attempts to bind within the active site. A snapshot structure of the ligand at any instant in time is called a “conformation,” and is defined by the set of torsion angles between rigid groups. The task of conformational searching is to determine the most complementary binding structure from all the permutations of potential shapes the ligand can assume. Because of the combinatorial nature of the problem, searching all the rotatable bond configurations a ligand can adopt is extremely demanding in terms of computer resources.

For example, builders typically employ the “odometer” algorithm to find the best-binding shape of a ligand has several rotatable bonds that can each potentially spin 360 degrees. The odometer algorithm is a systematic sampling of all possible torsion angle combinations. Like an odometer, the first bond is fully rotated 360 degrees before the second bond is incremented. When the second bond is incremented, the first bond is reset and then fully scanned again. This continues until the second bond is fully rotated, at which time the third bond is incremented. Searching continues in this manner until all rotatable bond combinations are eventually sampled. During the conformational search, acceptable torsion angle ranges must be determined for each rotatable bond. When a rotatable bond is incremented, the atoms attached to the “swing arm” are checked against all receptor atoms and ligand groups within the vicinity. If contact exists, then that particular conformer is eliminated, so that only valid ligand conformations that conform to the active site are generated. The combinatorial nature of this problem leads to an exponential rise in the number of conformations that must be calculated. A ligand with four rotatable bonds that is sampled at ten-degree increments requires evaluation of 1,679,616 different conformations. A ligand with five rotatable bonds sampled at ten-degree increments requires evaluation of over 60 million conformations. Since drugs typically contain 10-15 rotatable bonds, conformational searching can easily overwhelm even the fastest computers, despite the development of algorithms that reduce the computational burden of conformational searching by orders of magnitude. Consequently, some builder packages do not implement conformational flexibility at all, or use other short-cuts that severely limit their ability to determine adequate ligand binding conformations. Others use rudimentary, pre-calculated torsion angle scans that lack the resolution to tightly dock compounds within the active site.

Hybrid programs are typically employed in de novo ligand generation. FIG. 8 illustrates the operation of a typical hybrid program. A given active site 810 has three distinct regions 812, 814, and 816. The goal of the hybrid program is to generate a complete ligand that complements the active site 810. To do so, the program employs a combination of scanner and builder algorithms. The program first utilizes a scanner strategy to find components that will complement individual subsites within the active site 810 volume, such as the sets of components 822, 824, and 826 shown in FIG. 8. Individual components are then docked into their respective regions within the active site, as, for example, shown in FIG. 8 with the components 832, 834, and 836. Splicing fragments are then used to join the individual components 832, 834, and 836 into one or more complete ligands 850. Because numerous possible fragments may exist that complement the various active site regions a potentially large number of ligands may be generated by combinatorially linking the various components.

The strength of hybrid programs is in their ability to generate a large number of diverse potential hits. However, they suffer the same shortcomings as all de novo design packages described above: their performance is restricted by the inability to accurately calculate ligand-receptor binding affinity; the combinatorial nature of the algorithm often leads to the generation of chemical structures that violate the laws of physics, are unstable, or are synthetically difficult; and the developer of the software may bias the generation of compounds.

Thus, an improved system and method for computer-aided drug design is needed which is less restricted by accuracy of calculated ligand-receptor binding affinity, which better copes with the flexibility of ligands and its affect on binding affinity, and which limits the generation of undesirable compounds and the likelihood of biasing results with assumptions made in development.

### SUMMARY OF THE INVENTION

A first embodiment system for generating derivative compounds comprises software adapted to generate a component database by dividing structures in a user's structure database.

A second embodiment system for generating derivative compounds comprises software adapted to generate a component database, the component database having a diversity index that describes a plurality of chemical attributes including at least the size, polarity, and valence of each component in the database.

A third embodiment system for generating derivative compounds employs heuristic active site mapping in selecting groups for substitution.

A fourth embodiment system for generating derivative compounds comprises software comprising user-directed structure generation functionality which permits a user to identify portions of the lead compound that are to be optimized and to constrain the groups that can be selected for substitution into those portions.

A fifth embodiment system for generating derivative compounds comprises software comprising user-directed structure generation functionality which permits a user to identify unacceptable structures that will be removed from the set of derivative compounds generated by the system.

A sixth embodiment system for generating derivative compounds comprises software comprising user-directed structure generation functionality. The user-directed structure generation functionality permits a user to identify portions of the lead compound that are to be optimized and to constrain the groups that can be selected for substitution into those portions, and to identify unacceptable structures that will be removed from the set of derivative compounds generated by the system. The system further comprises software adapted to generate a component database by dividing structures in a user's structure database at each rotatable bond to generate non-rotatable groups, the component database having a diversity index that describes a plurality of chemical attributes including at least the size, polarity, and valence of each component in the database. The system further comprises software that implements heuristic active site mapping in selecting groups for substitution. Each non-rotatable group is stored in a component database with a unique label and a description of its chemical composition.

A seventh embodiment system for generating derivative compounds comprises a component specification language adapted to permit template-driven structure generation.

An eighth embodiment system for generating derivative compounds comprises software adapted to permit a user to generate focused scoring functions, and further comprises software adapted to use the focused scoring functions to bias the selection of derivative compounds towards those most likely to interact most strongly with a receptor.

A ninth embodiment system for generating derivative compounds employs target functions to select derivative compounds for retention during at least one generation of an iterative derivative compound generation system.

A tenth embodiment system for iteratively generating derivative compounds comprises software comprising user-directed structure generation functionality. The user-directed structure generation functionality permits a user to identify portions of the lead compound that are to be optimized and to constrain the groups that can be selected for substitution into those portions, and to identify unacceptable structures that will be removed from the set of derivative compounds generated by the system. The system further comprises software adapted to generate a component database by dividing structures in a user's structure database at each rotatable bond to generate non-rotatable groups. The component database has a diversity index that describes a plurality of chemical attributes including at least the size, polarity, and valence of each component in the database. The system further comprises software that implements heuristic active site mapping in selecting groups for substitution, and software implementing target functions to select derivative compounds for retention during at least one generation of the iterative generating of derivative compounds. Each non-rotatable group is stored in a component database with a unique label and a description of its chemical composition.

### BRIEF DESCRIPTION OF THE DRAWINGS

FIG. 1 is an example of an active site.

FIG. 2 is a schematic illustration of typical ligand-receptor binding interactions.

FIG. 3 is a schematic illustration of a pharmacophore and its relationship to ligand-receptor binding.

FIGS. 4A and 4B schematically illustrate the biochemical mechanism of a protease, and its inactivation through ligand manipulation.

FIG. 5 is a diagram of a typical drug design pipeline, in which a system and method according to the present invention may advantageously be used.

FIG. 6A and 6B schematically illustrate how scanner-type prior art drug design programs operate.

FIG. 7 schematically illustrates how builder-type prior art drug design programs operate.

FIG. 8 schematically illustrates how hybrid-type prior art drug design programs operate.

FIGS. 9A and 9B schematically illustrate how a system according to the present invention constructs a component database from a user's structure database.

FIG. 10 schematically illustrates the mapping of chemical characteristics of a receptor for a heuristic active site mapping algorithm suitable for use with a system and method according to the present invention.

FIG. 11 schematically illustrates the creation of derivative compounds using a heuristic active site mapping algorithm according to the present invention that employs only component size, valence, and polarity.

FIG. 12 schematically illustrates an example of user-directed structure generation according to the present invention for a sample lead compound.

FIG. 13 schematically illustrates an example of a calculated scoring function derived from four complexes whose binding affinity has been measured and whose descriptors have been calculated.

FIGS. 14A, 14B, and 14C are graphs showing common problems with the creation of accurate scoring functions.

FIGS. 15A, 15B, and 15C are flowcharts of software for computer-aided drug design according to the present invention.

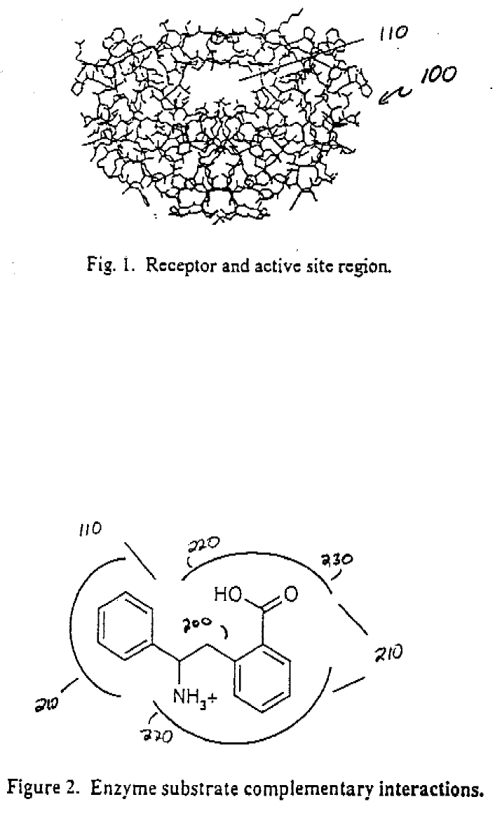

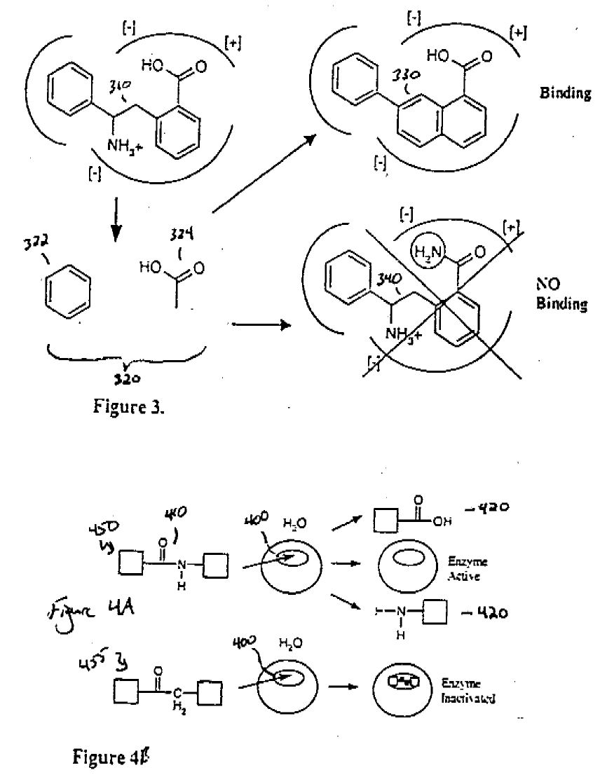

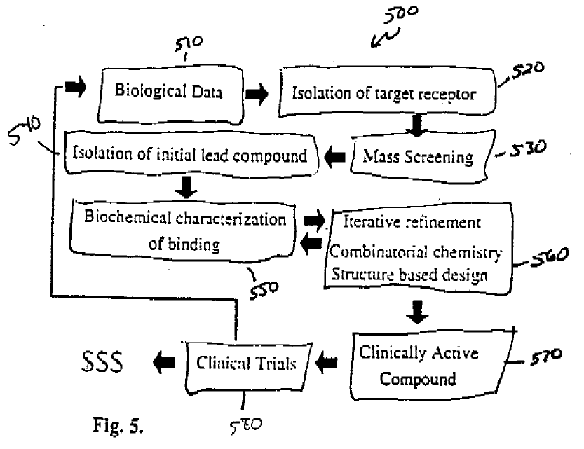

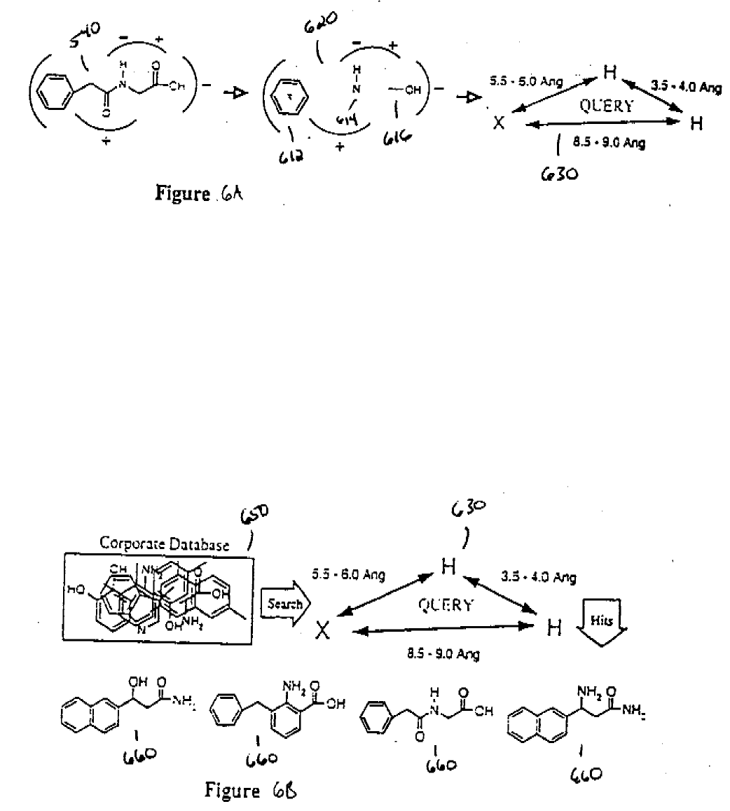

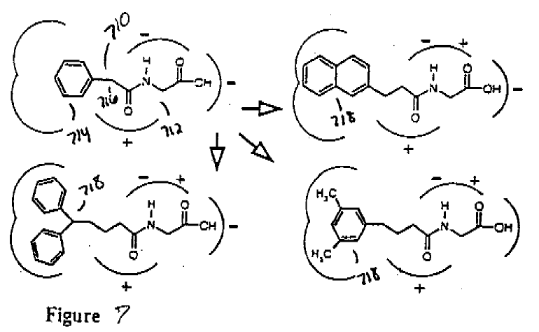

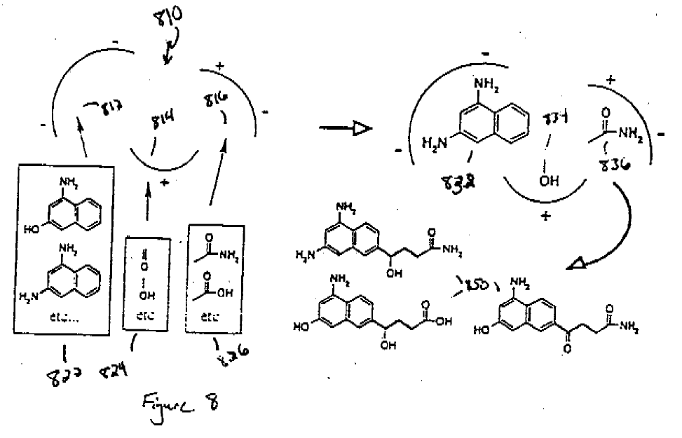

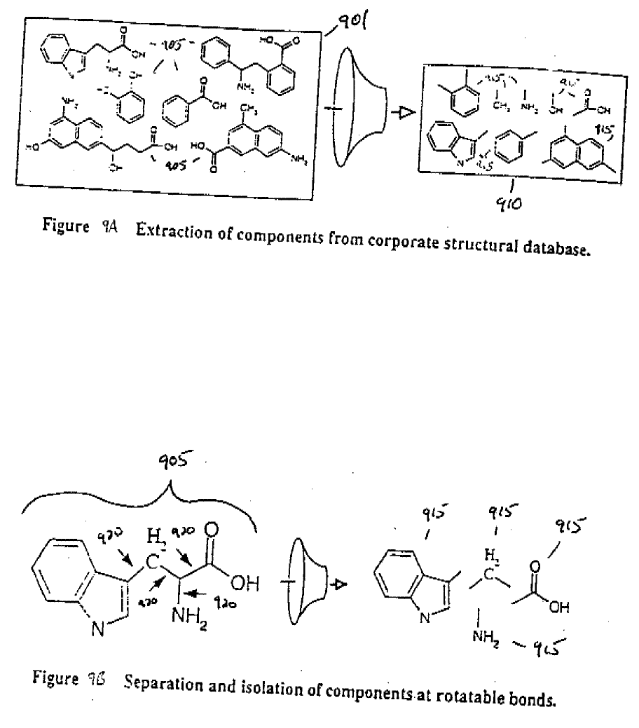

### DETAILED DESCRIPTION OF THE PREFERRED EMBODIMENTS

For the purposes of promoting an understanding of the principles of the invention, reference will now be made to the embodiment illustrated in the drawings and specific language will be used to describe the same. It will nevertheless be understood that no limitation of the scope of the invention is thereby intended. Alterations and modifications in the illustrated device, and further applications of the principles of the invention as illustrated therein are herein contemplated as would normally occur to one skilled in the art to which the invention relates.

A preferred embodiment improved system for computer-aided drug design according to the present invention is well adapted to use information about well-characterized classes of compounds to design new drugs. A preferred embodiment system according to the present invention offers a powerful means to improve the generation of complementary ligands—a crucial step in the generation of new drug treatments. A preferred embodiment system according to the present invention also provides the ability to easily cross-reference components by chemical composition, which facilitates user-directed structure generation, and thus is another powerful aid to the development of new drugs.

For the purposes of this document, the terms “chemical structure” and “structure” refer to any collection of atoms that are chemically bonded. The terms “group” and “rigid group” refers to any structure that lacks any rotatable bond. For example, an amide bond (—CONH—) is both a structure and a rigid group, but a sugar molecule is a structure and not a group. Those skilled in the art will appreciate that, technically, water contains two rotatable bonds: two O—H bonds. Thus, water is a structure that contains rotatable bonds by chemical definition. However, rotating the O—H bond does not alter the structure of the water molecule since the hydrogen just rotates in place about the bond axis. Consequently, for the purposes of this document, the O—H bonds in water are not treated as rotatable bonds, and H₂O is both a structure and a group. Likewise, other hydrogen single-bonds are treated as non-rotatable, since they also do not give rise to different shapes when the bond rotates.

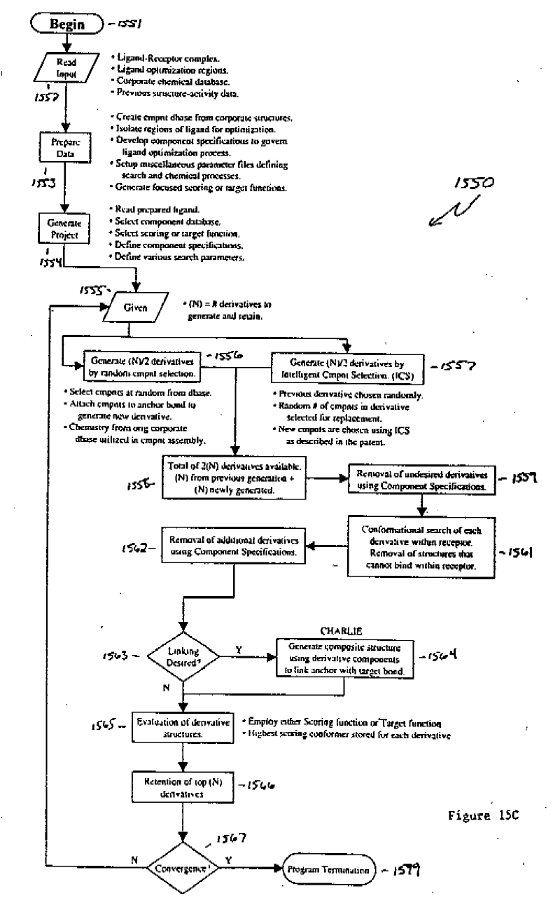

A preferred embodiment improved method for computer-aided drug design comprises generating a component database by pulling building block components from a user's structure database; generating diversity indices for the component groups that describe one or more chemical properties of the groups; selecting a lead compound for optimization; and creating generations of derivative compounds by replacing substituent fragments of compounds from one generation with component groups from the component database to create subsequent generations of compounds. During the creation of derivative compounds, the replacement of fragments is performed randomly during earlier generations, but is performed by a combination of a heuristic active site mapping algorithm and an intelligent component selection method in later generations. Referring to FIG. 15, a flowchart is shown for a preferred embodiment computer program that implements the above-described method, as described in greater detail hereinbelow.

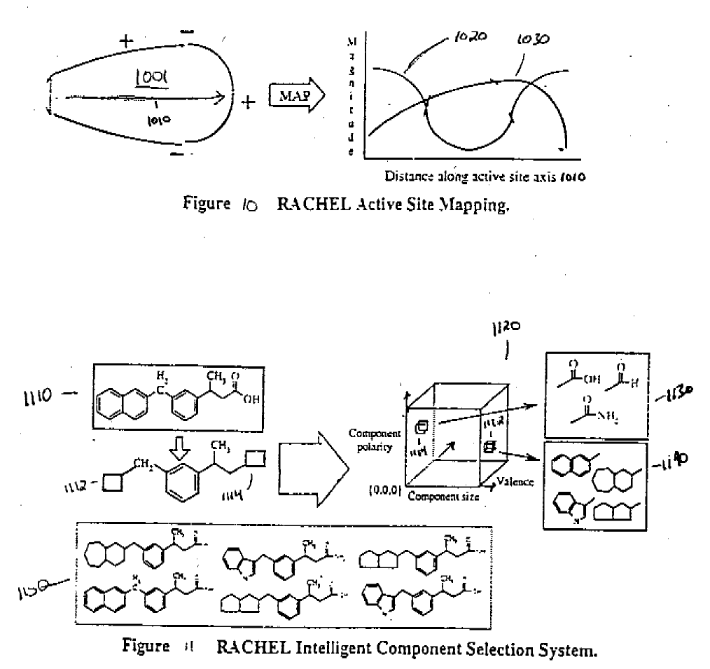

FIGS. 9A and 9B schematically illustrate the process of generating a component database 910 by pulling rigid components from a user's database 901, such as a corporate database. Note that the typical corporate database 901 will contain hundreds of thousands of structures 905. Chemical structures are composed of rigid, non-rotatable chemical groups 915 separated by rotatable bonds, as defined by the laws of chemistry and known to those skilled in the art. These rigid groups 915 are isolated by identifying the rotatable bonds 920 in the structures 905. The individual rigid groups 915 are then tagged with a component label and stored in the component database 910 along with their three-dimensional atomic coordinates and descriptions of their chemical composition. The component label is used to register each fragment and prevent the storage of redundant chemical groups. The descriptors of each group record chemical information characterizing the associated group, including the size of the component, atom composition, connectivity, hydrogen bond donor and acceptor groups, ring structure, and electrostatic charge.

Using the stored chemical attributes, all components 915 in the component database 910 are sorted and mapped into a multi-dimensional array called the “diversity index”. In this array, each axis represents a different chemical property. In one embodiment, only size, polarity, and valence are mapped. Preferably, other group traits are described and included in the component database 910 diversity index as well. Each axis of the array provides a gradient along which components 915 can be distinguished. Components 915 that are similar with respect to the various descriptors are grouped together along that axis. By generating this diversity index, a measure of the chemical diversity in the component database 910 is provided. More importantly, a means of rapidly cross-referencing and retrieving chemical components 915 in the database with respect to desired chemical properties is provided.

It will be appreciated that the component database 910 will typically be much smaller than the structure database 901 from which it is generated. For example, a typical corporate database 901 might contain approximately 100,000 structures 905 that consist of different combinations of only 5,000 rigid groups 915, so that the component database 910 would be only 5% of the size of the user's structure database 901. Nevertheless, depending on the size and diversity of the user's structure database 901, the component database 910 may be any size.

Once the component database 910 has been generated lead compounds can be selected and optimized. Regions of the lead compound that degrade receptor-binding affinity are replaced by groups from the component database 910 to generate new compounds. In an iterative fashion, these regions of the new compounds are then replaced to create further generations of new compounds. In the preferred embodiment, the selection of components 915 from the component database 910 is random during the early generations of substitutions in order to help ensure adequate sampling of the database and to help generate novel solutions.

In later generations, however, the preferred embodiment employs a heuristic active site mapping algorithm to determine superior chemical characteristics to complement a given region of the active site. Over time, the preferred embodiment maintains a record of chemical components 915 that improve ligand-receptor interaction along with their three-dimensional location within the active site. The heuristic active site mapping algorithm employs this data to generate a corresponding three-dimensional map that details the optimal chemical features, such as electrostatic charge and volume, that a group must possess to bind within a specific region of the active site, as illustrated in FIG. 10. The active site of the receptor 1001 in FIG. 10 is more positively charged at the ends, with respect to the indicated axis 1010, and more negatively charged in the middle. The active site 1001 is generally oblong, and narrower at one end. These features correspond to the graphs of charge 1020 and size 1030.

In the preferred embodiment, during later generations of derivation an intelligent component selection system is used to select optimal derivative components. The intelligent component selection system uses a heuristic active site mapping algorithm to learn, over time, the three dimensional location and chemical characteristics of the optimal components that bind the active site. This information is then applied to screen the component database 910, using the diversity index described above, to isolate chemical components 915 that are similar to the features specified by the active site map to create lists of candidate fragments. These fragments are then used to derivatize the lead compound in a combinatorial fashion to generate ligands with improved receptor complementarity.

FIG. 11 schematically illustrates an example of the later-generation creation of a derivative compound using an intelligent component selection system according to the present invention. In the example shown, the intelligent component selection system uses a heuristic active site mapping algorithm according to the present invention employing only component size, valence, and polarity. In this example, the naphthalene group 1112 and carboxylic acid group 1114 of a ligand derivative 1110 have been selected for replacement with other component groups. As the diversity index graph 1120 shows, the naphthalene group 1112 is large and very non-polar, since it is a bi-cyclic ring structure and is strictly hydrocarbon. Conversely, the carboxylic acid group 1114 is quite small, but highly polar. Assume that, using an active site map as described above, it is determined that these characteristics are ideal for complementing the receptor at each respective component. The diversity index is used to cross-reference and extract other components 915 from the component database 910 that exhibit similar characteristics, such as those shown in the set of small, polar groups 1130 and in the set of large, non-polar groups 1140. These components 915 are then combinatorially used to generate a new family of derivatives, such as those shown in the group of derivatives 1150. Each derivative retains the good receptor binding characteristics, but enough variability is generated to potentially improve receptor complementarity.

In the preferred embodiment, a component specification language is also used to give the computational chemist the ability to help select component groups for substitution that are most likely to improve the binding affinity of a derivative compound. The component specification language contains a combination of keywords, target values, and Boolean operators. A brief summary of sample commands appropriate for the component specification language is listed below:

| Command | Function |
|---|---|
| CMPNTS min-max | Number of total components to utilize. |
| ATOMS min-max | Number of atoms in a specific component. |
| R-ATOMS min-max | Number of ring atoms in a specific |
| | component. |
| MW min-max | Molecular weight. |
| LINKS atypes (<, >, =) value | Specifies rotatable bond atom types |
| | between components. |
| ATYPES (list) (<, >, =) value | Specifies atom type requirements in a |
| | specific component. |
| BONDS (list) (<, >, =) value | Specifies bonded atom types within a |
| | specific component. |
| PHARM (atype) {x, y, z} | Specifies a specific pharmacophoric group |
| | at coordinates {xyz}. |

Once the chemical requirements are established for each derivative group the master component database 910 is filtered using the component specification language to generate individual databases used to select groups for substitution for each subsite.

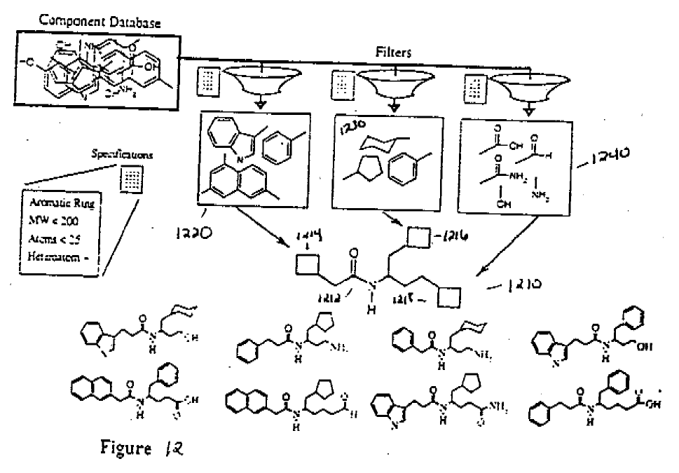

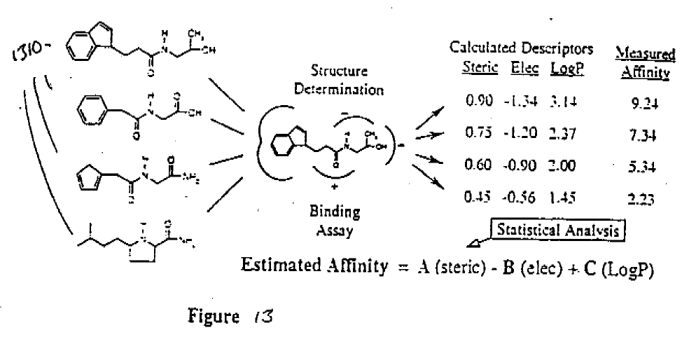

FIG. 12 illustrates an example of the use of the component specification language to generate new lead compound derivatives. The lead compound 1210 comprises a scaffold containing an amide bond 1212 with a first side chain 1214, a second side chain 1216, and a third side chain 1218 extending from it. In this example, assume that a biochemical characterization of this lead compound reveals that three chemical groups make up the pharmacophore. The first group 1220 must contain a large ring system. Crystallographic analysis reveals that both single and bi-cyclic rings are capable of binding, as long as they are planar. Thus, they must be aromatic. Any atom types may be accepted. The second group 1230 again requires a cyclic component, but the binding pocket in this region is smaller and more spherical. Thus, only single rings are acceptable, and they need not be aromatic. In addition, this region is very hydrophobic; thus, only hydrocarbon components 915 are acceptable (only carbon and hydrogen). The third group 1240 fits a region of the active site that is highly charged, and so requires a small polar group. Thus, no ring structures are acceptable and heteroatoms are required. With these chemical requirements established the computational chemist can employ the component specification language to filter the master component database 910 to generate individual sub-databases. In other words, the groups 1220, 1230, and 1240 are populated by filtering the master component database 910 to select only those components 915 which match the criteria selected and implemented through the component specification language. All possible derivatives within the constraints of the active site can then be combinatorially generated.

In the preferred embodiment the component specification language also permits the removal of undesired structures. For example, in the preferred embodiment, the ATOM and RATOM constraints described above govern how many atoms a particular component can possess. The LINK constraint likewise limits the atom types that can be used in the rotatable bonds. The PHARM specification signifies that a specific atom type must be present at a precise location in the active site. The #CMPNTS restriction places upper and lower bounds on the total number of components 915 a structure can possess. The ATYPE constraint stipulates how many atoms of a specific type can be present in both individual components 915 as well as the entire structure. The BOND specification places limits on the bonded atom types that can be present within a component. Collectively, these commands provide the user with great flexibility in defining undesirable structures and elements of structures. The component specification language permits these definitions to be used as an integral part of the generation of derivative compounds, in order to channel computer resources into the generation of potentially viable structures.

In the preferred embodiment, the component specification language also permits the user to define chemical templates to direct the generation of derivative compounds. A template comprises a set of specific user-defined components 915, each of which comprises one or more chemical criteria as specified by the component specification language, separated by wildcard designations, which denote where chemical variability can occur. So, for example, the user might define a template containing a carbonyl group separated from a phenyl group by one wildcard, and separated from a particular hydrocarbon chain by a second wildcard. Template-driven structure generation will then produce chemically diverse structures in which various appropriate components 915 replace the wildcards, while the hydrocarbon chain, carbonyl group, and phenyl group remain constant. In the preferred embodiment, constraints can also be placed on the wildcard regions in order to control the range of variation, so as to, for example, preserve the spatial location of the constant components 915 with one another.

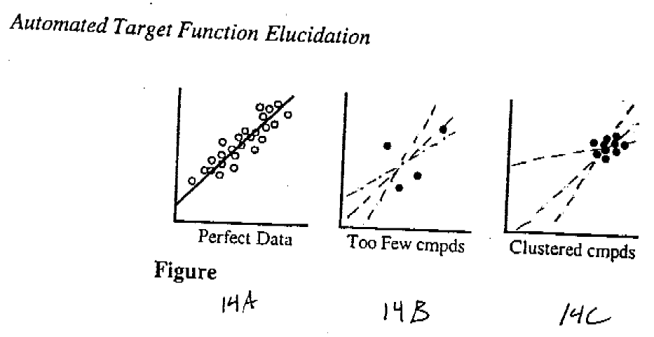

In the preferred embodiment, focused scoring functions are used to calculate the receptor binding affinity for the newly generated derivative ligands. As will be known to those skilled in the art, scoring functions estimate ligand-binding affinity using descriptors that can be measured from the ligand receptor interaction. In essence, a scoring function is an equation that relates measurable descriptors of binding to ligand receptor affinity. FIG. 13 illustrates an example derivation of a scoring function using four complexes 1310 whose binding affinities have been measured and whose descriptors have been calculated. Statistical tools, such as partial least squares regression, are employed to generate the equation relating the numerical trends in the various descriptors, including steric complementarity, electrostatic energy, and hydrophobicity, with the corresponding binding affinities. The resulting equation is the scoring function, which provides an estimated affinity as a function of the calculated descriptors. Note that the example shown in FIG. 13 is quite simplistic—a typical scoring function may contain 20 or more terms. Nevertheless, scoring functions only very crudely estimate the Gibbs free energy of the reaction.

Compounding this problem is the fact that most prior art commercial packages use a single generalized scoring function that has been derived using a wide variety of structures. There are two significant problems with this approach. Firstly, receptor systems vary considerably in their chemical makeup. In some systems, electrostatic interactions dominate the ligand binding force. In other systems, hydrophobic interactions overshadow the other forces involved. Using a variety of ligand receptor systems in the training set can add considerable noise to the data, which diminishes its predictive power. Secondly, when the generalized scoring function is integral to the software package, this again injects developer bias into the solutions that will be generated.

The preferred embodiment incorporates statistical and analytical tools that allow the user to generate focused scoring functions to estimate ligand binding to a specific target receptor using structure-activity data the user may have specific to the target receptor being studied. This allows, for example, companies who have characterized the receptor binding of a number of lead compound derivatives to utilize this knowledge in the derivation of the focused scoring functions. By limiting the training set to structures binding within the same receptor, we bias the scoring function towards the interactions that govern ligand association with the target active site. Thus, if hydrophobic contacts predominate, the hydrophobic descriptors will be emphasized. If electrostatic forces are important to binding, those descriptors will be accentuated. Even something as simple as the size of the active site can have a tremendous impact on the allowable ligands. This is a descriptor that would be lost given a multitude of different training set receptors. As such, focused scoring functions have far more predictive power with respect to estimating ligand-receptor binding than generalized scoring functions.

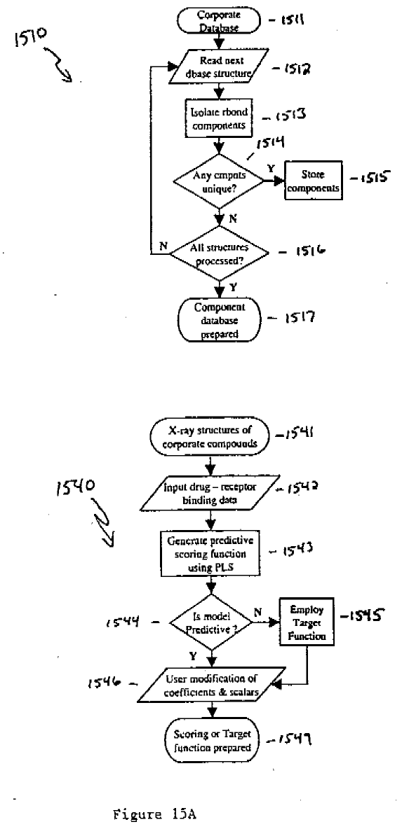

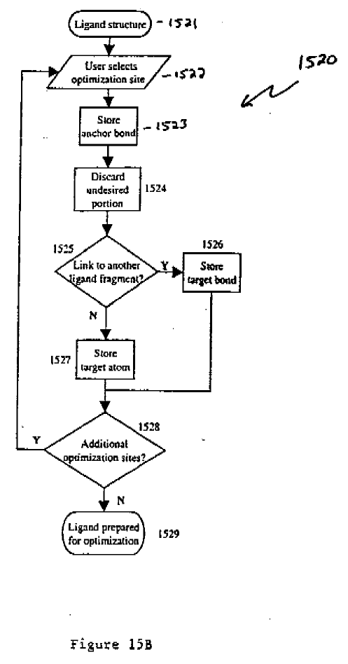

Even with structure-activity data pertaining to a target receptor, difficulties in generating accurate scoring functions may arise, as depicted in FIGS. 14A, 14B, and 14C. Firstly, there must be an adequate number of compounds to make the analysis statistically valid. In each graph, the dots schematically represent the structure-activity data of a collection of ligands bound to a target receptor. The lines passing through them represent potential scoring functions attempting to describe their distribution. The graph in FIG. 14A illustrates an ideal distribution of complexes that allows for an easy determination of a best-fit line. This data set contains a large number of complexes whose activity covers a wide range of values. A scoring function generated from this set thoroughly represents the data. The graph in FIG. 14B is a more representative of the situation most often faced in academic research. Here there are too few compounds to generate an accurate fit of the data. Notice the ambiguity that exists in determining the best-fit curve. Any scoring function derived from this dataset has little predictive value. The graph in FIG. 14C is another scenario that might occur. Here, there is no lack of data. However, given money and time constraints in drug development projects, it can be difficult to justify crystallographic studies on poorly binding compounds. As such, crystal structures of compounds are usually determined only when high affinity structures have been found by assay. Therefore, a cluster of high-affinity data points is produced. As one can see from FIG. 14C, it is also difficult to elucidate an accurate scoring function when the structure activity data is not broad enough.

In the preferred embodiment, when it is determined that the derived scoring function offers little predictive value, a focused target function is then used. A target function is formed by simply averaging the descriptor values of the highest affinity training set complexes. This produces a target point in multidimensional descriptor space, where each dimension is a measured chemical descriptor. In effect, the target function is a scoring function that is derived from a single point, rather than a best-fit line. Compounds are scored using an inverse-distance function from the target point. Those derivative structures whose descriptor values are closest to the target have higher scores and are retained, while those further from the target are scored lower and are rejected.

It will be appreciated that the target function is easy to implement. A large training set of compounds is not required. Even a single compound can be used as a model for optimal ligand receptor binding. By simply extracting the descriptor values of the best compounds, many of the pitfalls in scoring function development that result from data artifacts are avoided. In addition, the characteristics of the ligand-receptor association that foster improved binding are allowed to drive the development of future structures. Conversely, the principle disadvantage of using target functions is the lack of extrapolation. In other words, target functions constrain the system using the properties of previously characterized ligands. Thus, target functions are not well suited to predict whether a new derivative compound can bind better to the receptor than our best compounds. Target functions are also not well suited to quantitate the binding relative to the other structures in the training set. While the system is employing target functions, it is simply building structures that mimic the characteristics of the best compounds. However, this is often precisely the task at hand for pharmaceutical chemists. By the time a drug development project has reached maturity, the ligands that have been developed are often optimal binding compounds. Therefore, a target function is usually sufficient as it allows the drug designer to construct alternative chemical architecture that retains optimal binding characteristics.

In order to use the preferred embodiment system according to the present invention, the user must first input parameters for the design task. These parameters preferably include: the crystal structure of a lead compound that is to be optimized; the regions of the lead compound that are to be replaced and optimized; and the user's database of known compounds, including proprietary compounds. The input parameters may also advantageously include structure-activity data of previously characterized compounds.

Once the input parameters are provided, the user first uses the system to specify the regions of the lead compound that must be replaced to improve receptor binding. A lead compound normally contains a region of high receptor complementarity (the scaffold) attached to regions that diminish binding. These regions are referred to as optimization sites. Each optimization site is separated from the scaffold by an “anchor bond”, which provides the attachment point for the addition of replacement components 915. The user simply selects the anchor bonds to designate the regions that will be optimized by the preferred embodiment system.

The user then uses the system to create a component database 910 from the user's structural database by extracting and registering chemical building-block fragments. With each component registered in the database, the system stores the 3 D atomic coordinates along with numerous other chemical properties—including size, atom types, bond types (connectivity), and electrostatic charge. The user also uses the system's component specification language to establish restrictions governing generation of derivative compounds. The user may also advantageously use the system to generate focused scoring functions, target functions, or both, using structure-activity data from previously characterized compounds.

The user can then use the system to generate the derivative compounds. The user must specify the number (“N”) of derivative structures to be generated and retained in each iteration, and the number of iterations that the system must complete without finding a new compound before the system will terminate the operation. The system then iteratively substitutes new groups for portions of the lead compound that were identified for optimization.

In each iteration, the system generates N/2 different derivatives by random selection of components 915 from the component database 910. Components 915 are added to the anchor bond, and connectivity information that was extracted from the original user's database is used to assemble the fragments. Components 915 are chemically joined according to the laws of chemistry and within the user-defined constraints as specified by the component specification language.

In each iteration, the other N/2 derivatives are generated by intelligent component selection. A previously generated derivative is selected at random, and a random number of its components 915 are selected for replacement. For each component to be replaced the chemical characteristics most likely to complement the receptor at that location are determined using the heuristic active site map. These characteristics are then used to select a list of suitable replacement fragments by cross-referencing the diversity index of the component database 910. From this list, a new component is selected at random.

At the end of each iteration, the system has a total of 2N derivative structures; N from the previous iteration, and N from present one. Component specifications are then used to remove combinations of structures that have been identified by the input parameters to be unacceptable (because they cannot be economically synthesized, because they are toxic, etc.). The system then performs a conformational search for each surviving compound to identify the conformation with the highest binding affinity (which can be determined by either a scoring function or a target function, depending on the input parameters and the present iteration). This conformation is retained and the others are discarded. The compounds are ordered based on their binding affinities, and the top N compounds are retained for the next iteration. The process continues until no additional unique compounds are retained for the number of iterations that was selected by the user.

FIGS. 15A, 15B, and 15C show flowcharts for a computer program that implements the above-described method. The program includes a component database preparation subroutine 1510, as shown in FIG. 15A, a ligand preparation subroutine 1520, as shown in FIG. 15B, a scoring function preparation subroutine 1540, as shown in FIG. 15A, and a ligand optimization subroutine 1550, as shown in FIG. 15C.

The ligand optimization subroutine 1550 begins at 1551. At 1552 the process input is read, including the atomic coordinates of the ligand-receptor complex (the natural ligand and receptor, “docked” together), the ligand optimization regions as determined in subroutine 1520 below, the user's database 901 (assuming one is being used), and whatever structure-activity data is available. At step 1553 the data is prepared. The component database 910 is constructed from the user's database 901, and regions of the ligand are isolated for optimization by the subroutines 1510 and 1520, respectively, as described in greater detail hereinbelow. Component specifications are developed to govern the ligand optimization process, and appropriate parameter files are set up defining the search and the chemical processes (including, for example, the number of structures (N) to retain after each iteration). Scoring or target functions, or both, are prepared, as appropriate, by the subroutine 1540, as described in greater detail hereinbelow. At 1554 the ligand optimization project is generated. The prepared ligand is read, the desired component database is selected, and the appropriate scoring or target function is selected. Any limitations on component specification or search parameters are chosen.

At 1555 the number “N” of derivatives to be generated in each generation is selected. At 1556 half of the selected number of derivatives is generated by random component selection. Each of these derivatives is created by selecting components at random from the component database 910 to attach at each of the identified anchor bonds. Although selected randomly from the database 910, the selection of components may be restricted by various search parameters and component specifications set out at step 1554. At 1557 half of the selected number of derivatives is generated by intelligent component selection. Each of these derivatives is generated by selecting one of the previously generated ligands (either at 1556, or in a previous generation of derivation), and selecting a random number of component substructures in the previously generated ligand for replacement. Those component substructures are then replaced with components that are expected to provide higher receptor-binding activity as dictated by a heuristic active site mapping algorithm, as discussed in greater detail hereinabove with respect to FIG. 11.

At step 1558 there are 2N derivatives available, N from the previous generation and N from the present generation. At step 1559 species that are undesirable regardless of conformation are removed using the component specifications set out at step 1554, so that computer resources are not devoted to useless conformational searching. Then at 1561 a conformational search of each remaining derivative is performed to find the best-binding conformation for each remaining compound. At step 1562 additional undesired derivatives are removed using the component specifications set out at step 1554. At step 1563 it is determined whether linking is desired. If so, at step 1564 composite structures are generated by connecting the anchor bond with the target bond via derivative components. After step 1564, or 1563 if linking is not being performed, at 1565 the 2N derivative structures are evaluated according to the scoring or target function. At step 1566 the lower-scoring N. derivative structures are removed. At step 1567 the surviving N structures are compared to the surviving N structures from the previous generation to determine whether the process has converged (i.e., whether there are at least a pre-determined number of new derivatives in the present generation that were absent from the previous generation). If the process has not converged, the program returns to steps 1556 and 1557 to create a new generation of derivatives. Otherwise, the program terminates at 1599.

The subroutine 1510 for constructing a component database 910 from a user's database 901 begins at 1511. At 1512 the first unread structure in the user's database 901 is read. At 1513 the rotatable bonds of the read structure are identified, and used to partition the structure into component groups. At 1514 it is determined whether any of these groups are absent from the component database 910. If so, the new group or groups are stored in the component database 910, in association with an appropriate tag identifying the group and its features, including geometry, etc., as described hereinabove. After the new groups are stored, or if no new groups were identified, it is determined whether all structures have been read from the user's database 901. If not, the subroutine 1510 returns to step 1512, otherwise, the subroutine 1510 terminates at step 1517.

The subroutine 1520 for preparing a ligand for optimization begins at 1521. At 1522 the user selects a site on the ligand for optimization. At 1523 the atoms defining the anchor bond separating the region to be optimized from the scaffold are stored. At 1524 the portion of the ligand distal to the anchor bond is removed from the ligand's structure. As described above, in the preferred embodiment components from the database are combinatorially added to the anchor bond in order to optimize ligand-receptor interactions. In addition, in the preferred embodiment the user can link one ligand scaffold to another in order to generate composite ligands by bridging the space between. At 1525, if the user wishes to bridge to another ligand scaffold a target bond is selected at 1526 and stored. This bond will serve as a target towards which the developing derivative chain will be grown and attempt to splice. If linking is not desired, a target receptor atom is instead selected at 1527 and stored. This target receptor atom directs the growing derivative chain to ensure that the appropriate region of the active site will be filled and optimized. At 1528 it is determined whether the user wishes to optimize any additional sites on the ligand. If so, the subroutines 1520 returns to 1522, otherwise the subroutine terminates at 1529.

The subroutine 1540 for preparing scoring or target functions begins at 1541. At 1542 receptor binding data is input. At 1543 a predictive scoring function is generated using partial least squares regression (“PLS”), as described earlier. At 1544 it is determined whether the scoring function model generated at 1543 is predictive. If not, a target function is selected at step 1545. After step 1545, or 1544 if the scoring function was determined to be predictive at 1544, at 1546 the user can perform modifications of the coefficients and scalars of the scoring or target function. At 1549 the subroutine ends.

While the invention has been illustrated and described in detail in the drawings and foregoing description, the same is to be considered as illustrative and not restrictive in character. Only the preferred embodiment, and certain alternative embodiments deemed useful for further illuminating the preferred embodiment, has been shown and described. All changes and modifications that come within the spirit of the invention are desired to be protected.

We claim:

1. A system for generating derivative compounds comprising software adapted to generate a component database by dividing structures in a user's structure database.

2. The system of claim 1, wherein the software adapted to generate a component database divides the structures in the user's structure database at each rotatable bond to generate non-rotatable groups.

3. The system of claim 2, wherein each non-rotatable group is stored in a component database with a unique label and a description of its chemical composition.

4. A system for generating derivative compounds comprising software adapted to generate a component database, the component database having a diversity index that describes a plurality of chemical attributes including at least the size, polarity, and valence of each component in the database.

5. The system of claim 4, wherein the software adapted to generate a component database is further adapted to generate the component database from a user's structure database.

6. The system of claim 5, wherein the software adapted to generate a component database divides the structures in the user's structure database at each rotatable bond to generate non-rotatable groups.

7. A system for generating derivative compounds employing heuristic active site mapping in selecting groups for substitution.

8. The system of claim 7, comprising software adapted to generate a component database by dividing structures in a user's structure database.

9. The system of claim 8, wherein the software adapted to generate a component database divides the structures in the user's structure database at each rotatable bond to generate non-rotatable groups.

10. The system of claim 7, comprising software adapted to generate a component database, the component database having a diversity index that describes a plurality of chemical attributes including at least the size, polarity, and valence of each component in the database.

11. The system of claim 10, wherein the software adapted to generate a component database is further adapted to generate the component database from a user's structure database.

12. The system of claim 11, wherein the software adapted to generate a component database divides the structures in the user's structure database at each rotatable bond to generate non-rotatable groups.

13. A system for generating derivative compounds comprising software comprising user-directed structure generation functionality which permits a user to identify portions of the lead compound that are to be optimized and to constrain the groups that can be selected for substitution into those portions.

14. The system of claim 13, further comprising software adapted to generate a component database by dividing structures in a user's structure database.

15. The system of claim 14, wherein the software adapted to generate a component database divides the structures in the user's structure database at each rotatable bond to generate non-rotatable groups.

16. The system of claim 15, wherein each non-rotatable group is stored in a component database with a unique label and a description of its chemical composition.

17. The system of claim 13, further comprising software adapted to generate a component database, the component database having a diversity index that describes a plurality of chemical attributes including at least the size, polarity, and valence of each component in the database.

18. The system of claim 17, wherein the software adapted to generate a component database is further adapted to generate the component database from a user's structure database by dividing the structures in the user's structure database at each rotatable bond to generate non-rotatable groups.

19. The system of claim 13, further comprising software that implements heuristic active site mapping in selecting groups for substitution.

20. The system of claim 19, further comprising software adapted to generate a component database by dividing structures in a user's structure database.

21. The system of claim 20, wherein the software adapted to generate a component database divides the structures in the user's structure database at each rotatable bond to generate non-rotatable groups.

22. The system of claim 19, further comprising software adapted to generate a component database, the component database having a diversity index that describes a plurality of chemical attributes including at least the size, polarity, and valence of each component in the database.

23. The system of claim 22, wherein the software adapted to generate a component database is further adapted to generate the component database from a user's structure database.

24. The system of claim 23, wherein the software adapted to generate a component database divides the structures in the user's structure database at each rotatable bond to generate non-rotatable groups.

25. A system for generating derivative compounds comprising software comprising user-directed structure generation functionality which permits a user to identify unacceptable structures that will be removed from the set of derivative compounds generated by the system.

26. A system for generating derivative compounds comprising:
software comprising user-directed structure generation functionality which permits a user to:
identify portions of the lead compound that are to be optimized and to constrain the groups that can be selected for substitution into those portions;
identify unacceptable structures that will be removed from the set of derivative compounds generated by the system;
software adapted to generate a component database by dividing structures in a user's structure database at each rotatable bond to generate non-rotatable groups, the component database having a diversity index that describes a plurality of chemical attributes including at least the size, polarity, and
valence of each component in the database; and
software that implements heuristic active site mapping in selecting groups for substitution;
wherein each non-rotatable group is stored in a component database with a unique label and a description of its chemical composition.

27. A system for generating derivative compounds comprising a component specification language adapted to permit template-driven structure generation.

28. A system for generating derivative compounds comprising software adapted to permit a user to generate focused scoring functions, and further comprising software adapted to use the focused scoring functions to bias the selection of derivative compounds towards those most likely to interact most strongly with a receptor.

29. The system of claim 28, further comprising software adapted to generate a component database by dividing structures in a user's structure database at each rotatable bond to generate non-rotatable groups.

30. The system of claim 28, further comprising software adapted to generate a component database, the component database having a diversity index that describes a plurality of chemical attributes including at least the size, polarity, and valence of each component in the database.

31. The system of claim 30, wherein the software adapted to generate a component database is further adapted to generate the component database from a user's structure database.

32. The system of claim 31, wherein the software adapted to generate a component database divides the structures in the user's structure database at each rotatable bond to generate non-rotatable groups.

33. The system of claim 28, further comprising software adapted to employ employing heuristic active site mapping in selecting groups for substitution.

34. The system of claim 33, comprising software adapted to generate a component database by dividing the structures in the user's structure database at each rotatable bond to generate non-rotatable groups.

35. The system of claim 33, comprising software adapted to generate a component database, the component database having a diversity index that describes a plurality of chemical attributes including at least the size, polarity, and valence of each component in the database.

36. The system of claim 35, wherein the software adapted to generate a component database is further adapted to generate the component database from a user's structure database by dividing the structures in the user's structure database at each rotatable bond to generate non-rotatable groups.

37. The system of claim 28, further comprising software comprising user-directed structure generation functionality which permits a user to identify portions of the lead compound that are to be optimized and to constrain the groups that can be selected for substitution into those portions.

38. The system of claim 37, further comprising software adapted to generate a component database by dividing structures in a user's structure database at each rotatable bond to generate non-rotatable groups.

39. The system of claim 38, further comprising software adapted to generate a component database, the component database having a diversity index that describes a plurality of chemical attributes including at least the size, polarity, and valence of each component in the database.

40. The system of claim 28, further comprising software that implements heuristic active site mapping in selecting groups for substitution.

41. The system of claim 40, further comprising software adapted to generate a component database by dividing structures in a user's structure database.

42. The system of claim 41, wherein the software adapted to generate a component database divides the structures in the user's structure database at each rotatable bond to generate non-rotatable groups.

43. The system of claim 40, further comprising software adapted to generate a component database, the component database having a diversity index that describes a plurality of chemical attributes including at least the size, polarity, and valence of each component in the database.

44. The system of claim 43, wherein the software adapted to generate a component database is further adapted to generate the component database from a user's structure database.

45. The system of claim 44, wherein the software adapted to generate a component database divides the structures in the user's structure database at each rotatable bond to generate non-rotatable groups.

46. A system for generating derivative compounds employing target functions to select derivative compounds for retention during at least one generation of an iterative derivative compound generation.

47. The system of claim 46, comprising software adapted to generate a component database by dividing structures in a user's structure database at each rotatable bond to generate non-rotatable groups, each non-rotatable group being stored in the component database with a unique label and a description of its chemical composition.

48. The system of claim 46, comprising software adapted to generate a component database, the component database having a diversity index that describes a plurality of chemical attributes including at least the size, polarity, and valence of each component in the database.

49. The system of claim 48, wherein the software adapted to generate a component database is further adapted to generate the component database from a user's structure database.

50. The system of claim 49, wherein the software adapted to generate a component database divides the structures in the user's structure database at each rotatable bond to generate non-rotatable groups.

51. The system of claim 46, further employing heuristic active site mapping in selecting groups for substitution.

52. The system of claim 51, comprising software adapted to generate a component database by dividing structures in a user's structure database at each rotatable bond to generate non-rotatable groups, the component database having a diversity index that describes a plurality of chemical attributes including at least the size, polarity, and valence of each component in the database.

53. The system of claim 46, comprising software comprising user-directed structure generation functionality which permits a user to identify portions of the lead compound that are to be optimized and to constrain the groups that can be selected for substitution into those portions.

54. The system of claim 53, further comprising software adapted to generate a component database by dividing structures in a user's structure database at each rotatable bond to generate non-rotatable groups, each non-rotatable group being stored in the component database with a unique label and a description of its chemical composition.

55. The system of claim 53, further comprising software adapted to generate a component database, the component database having a diversity index that describes a plurality of chemical attributes including at least the size, polarity, and valence of each component in the database.

56. The system of claim 55, wherein the software adapted to generate a component database is further adapted to generate the component database from a user's structure database by dividing the structures in the user's structure database at each rotatable bond to generate non-rotatable groups.

57. The system of claim 55, further comprising software that implements heuristic active site mapping in selecting groups for substitution.

58. The system of claim 46, comprising software comprising user-directed structure generation functionality which permits a user to identify unacceptable structures that will be removed from the set of derivative compounds generated by the system.

59. A system for iteratively generating derivative compounds comprising:
software comprising user-directed structure generation functionality which permits a user to:
identify portions of the lead compound that are to be optimized and to constrain the groups that can be selected for substitution into those portions;
identify unacceptable structures that will be removed from the set of derivative compounds generated by the system;
software adapted to generate a component database by dividing structures in a user's structure database at each rotatable bond to generate non-rotatable groups, the component database having a diversity index that describes a plurality of chemical attributes including at least the size, polarity, and valence of each component in the database;
software that implements heuristic active site mapping in selecting groups for substitution; and
software implementing target functions to select derivative compounds for retention during at least one generation of the iterative generating of derivative compounds;
wherein each non-rotatable group is stored in a component database with a unique label and a description of its chemical composition.
